(19) United States
(12) Patent Application Publication
(10) Pub. No.: US 2016/0026394 A1
(43) Pub. Date: Jan. 28, 2016

(54) IMAGE PROCESSING DEVICE, DATA ACCESSING METHOD, AND COMPUTER PROGRAM PRODUCT

(71) Applicant: Kabushiki Kaisha Toshiba, Minato-ku (JP)

(72) Inventor: Masataka GOTO, Yokohama (JP)

(73) Assignee: Kabushiki Kaisha Toshiba, Minato-ku (JP)

(21) Appl. No.: 14/699,031

(22) Filed: Apr. 29, 2015

(30) Foreign Application Priority Data
Jul. 24, 2014 (JP) 2014-151059

(51) Int. Cl. G06F 3/06

(52) U.S. Cl. CPC G06F 3/0608; G06F 3/0652; G06F 3/0679

(57) ABSTRACT

According to an embodiment, an information processing device includes a storage, an access controller, a counter, a determination processor, and a deleter. The storage includes a NAND-type flash memory to store data. The access controller is configured to output an access request for accessing the data stored in the storage. The counter is configured to, when the access request represents a request for reading, increment a reading count for a memory area of the storage specified in the access request by one. The determination processor is configured to determine whether or not the reading count reaches a predetermined count. The deleter is configured to, when the determination processor determines that the reading count reaches the predetermined count, delete first data that is stored in the memory area corresponding to the reading count.

### CROSS-REFERENCE TO RELATED APPLICATION

This application is based upon and claims the benefit of priority from Japanese Patent Application No. 2014-151059, filed on Jul. 24, 2014; the entire contents of which are incorporated herein by reference.

### FIELD

Embodiments described herein relate generally to an information processing device, a data accessing method, and a computer program product.

### BACKGROUND

In recent years, a NAND (Not AND) flash memory (hereinafter, simply called a NAND memory) is being used in a data memory device such as a USB memory (USB stands for Universal Serial Bus), an SD memory card (SD stands for Secure Digital), and a solid state drive (SSD); thereby enabling achieving a large memory capacity and enabling reading and writing at high speeds. Generally, it is a known that in a NAND memory, writing data many times leads to a physical damage to the memory elements; reading data many times causes a phenomenon in which the stored data gets damaged (what is called a read disturb phenomenon). As a countermeasure to the read disturb phenomenon occurring in a NAND memory, a technology has been proposed in which, of the data stored in a data memory device, the damaged data is restored using a predetermined algorithm.

However, in such a technology, since the algorithm for data restoration is executed at the time of reading the damaged data from a data memory device, there is an increase in the time taken for reading.

### BRIEF DESCRIPTION OF THE DRAWINGS

FIG. 1 is a diagram illustrating a hardware configuration of an information processing device according to a first embodiment;

FIG. 2 is a diagram illustrating a software configuration of the information processing device according to the first embodiment;

FIG. 3 is a configuration diagram of a solid state drive (SSD);

FIG. 4 is a configuration diagram of a NAND (Not AND) memory chip;

FIG. 5 is a diagram for explaining conversion between logical sectors and physical sectors;

FIG. 6 is a diagram illustrating a functional block configuration of the information processing device according to the first embodiment;

FIG. 7 is a diagram illustrating an exemplary reading count table according to the first embodiment;

FIG. 8 is a flowchart for explaining the operations performed in response to a data access request according to the first embodiment;

FIG. 9 is a diagram illustrating a functional block configuration of an information processing device according to a modification example of the first embodiment;

FIG. 10 is a diagram illustrating exemplary states of the logical sectors and the physical sectors before the data is deleted;

FIG. 11 is a diagram illustrating exemplary states of the logical sectors and the physical sectors after the data is deleted;

FIG. 12 is a diagram illustrating exemplary states of the logical sectors and the physical sectors after the data is written;

FIG. 13 is a diagram illustrating a software configuration of an information processing device according to a second embodiment;

FIG. 14 is a diagram illustrating a functional block configuration of the information processing device according to the second embodiment;

FIG. 15 is a diagram illustrating a software configuration of an information processing device according to a third embodiment;

FIG. 16 is a diagram illustrating a functional block configuration of the information processing device according to the third embodiment;

FIG. 17 is a diagram illustrating an exemplary reading count table according to the third embodiment;

FIG. 18 is a flowchart for explaining the operations performed in response to a system call that is output from an application according to the third embodiment;

FIG. 19 is a diagram illustrating an exemplary configuration of a client server system according to a fourth embodiment; and

FIG. 20 is a diagram illustrating an exemplary configuration of a client server system according to a modification example of the fourth embodiment.

### DETAILED DESCRIPTION

According to an embodiment, an information processing device includes a storage, an access controller, a counter, a determination processor, and a deleter. The storage includes a NAND-type flash memory to store data. The access controller is configured to output an access request for accessing the data stored in the storage. The counter is configured to, when the access request represents a request for reading, increment a reading count for a memory area of the storage specified in the access request by one. The determination processor is configured to determine whether or not the reading count reaches a predetermined count. The deleter is configured to, when the determination processor determines that the reading count reaches the predetermined count, delete first data that is stored in the memory area corresponding to the reading count.

Exemplary embodiments of an information processing device, a data accessing method, and a computer program product according to the invention will be described in detail below with reference to the accompanying drawings. In the accompanying drawings, the same constituent elements are referred to by the same reference numerals. However, the drawings are only schematic in nature, and the specific configuration should be determined by taking into account the explanation given below.

### First Embodiment

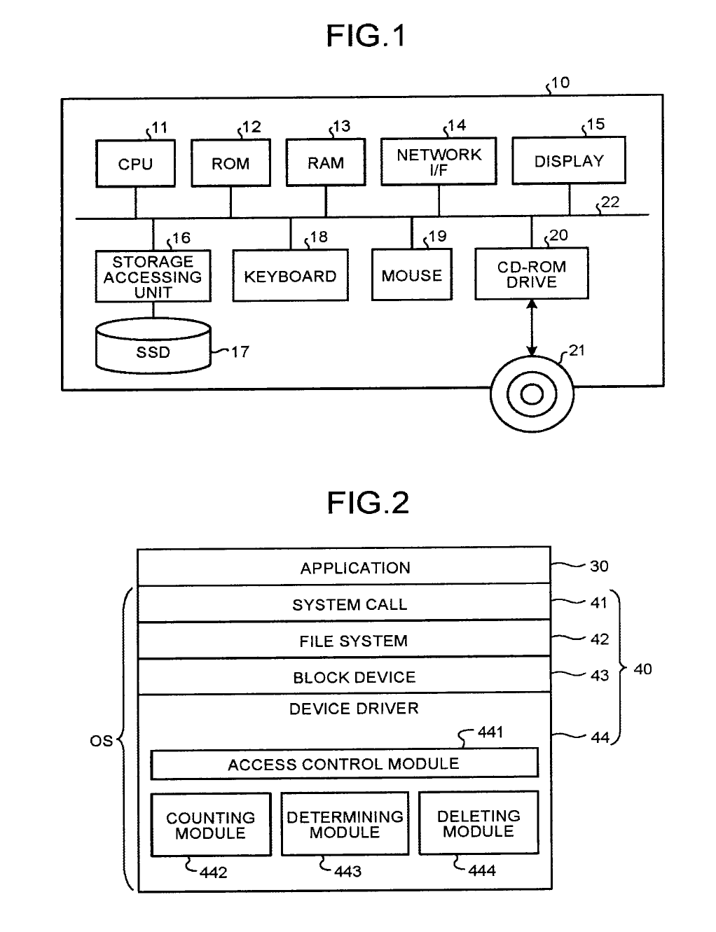

FIG. 1 is a diagram illustrating an exemplary hardware configuration of an information processing device according to a first embodiment. Thus, explained with reference to FIG. 1 is a hardware configuration of an information processing device 10 according to the first embodiment.

The information processing device 10 is a device such as a personal computer (PC), a workstation, or a server. As illustrated in FIG. 1, the information processing device 10 includes a central processing unit (CPU) 11, a read only memory (ROM) 12, a random access memory (RAM) 13, a network I/F 14 (an interface unit), a display 15, a storage accessing unit 16, a solid state drive (SSD) 17 (a storage), a keyboard 18, a mouse 19, and a CD-ROM drive 20 (CD-ROM stands for Compact Disk Read Only Memory).

The CPU 11 controls the operations of the entire information processing device 10. The ROM 12 is a nonvolatile memory device that is used in storing computer programs written for the information processing device 10.

The RAM 13 is a volatile memory device used as a work area of the CPU 11. The RAM 13 is used in storing various computer programs including applications as well as used in storing data that is used during various operations performed in the information processing device 10. The CPU 11 executes the applications in an operating system (OS) loaded in the RAM 13.

The network I/F 14 is an interface for communicating data with an external device via a network such as the Internet, a local area network (LAN), or a dedicated line.

The display 15 is a display device used to display a variety of information such as a cursor, menus, windows, characters, and images. Herein, for example, the display 15 is a CRT display (CRT stands for cathode ray tube), a liquid crystal display, a plasma display, or an organic EL display (EL stands for Electroluminescence).

The storage accessing unit 16 accesses the SSD 17 for the purpose of data reading, data writing, or data deletion in response to a data access request received from a device driver. The storage accessing unit 16 is connected to the SSD 17 using an interface standard such as the serial advanced technology attachment (SATA).

The SSD 17 is a memory device in which a flash memory is used as the storage medium. In the first embodiment, the SSD 17 includes a NAND memory as the flash memory.

The keyboard 18 is an input device used in inputting characters or numbers, selecting various instructions, and moving the cursor. The mouse 19 is an input device used in selecting and executing various instructions, selecting processing targets, and moving the cursor.

The CD-ROM drive 20 controls reading and writing of data with respect to a CD-ROM 21 that is an example of a detachable storage medium.

Meanwhile, the CPU 11, the ROM 12, the RAM 13, the network I/F 14, the display 15, the storage accessing unit 16, the keyboard 18, the mouse 19, and the CD-ROM drive 20 are communicably connected to each other via a bus 22 such as an address bus or a data bus.

FIG. 2 is a diagram illustrating an exemplary software configuration of the information processing device according to the first embodiment. Thus, explained below with reference to FIG. 2 is a software configuration of the information processing device 10 according to the first embodiment.

As illustrated in FIG. 2, the software of the information processing device 10 includes an application 30 and an OS 40.

The application 30 is a computer program used for the purpose of performing a particular task. The application 30 is executed by the CPU 11 in the OS 40 that is loaded in the RAM 13.

The OS 40 represents the basic software equipped with the functions for basic management and control of the information processing device 10 and equipped with the basic functions used in a shared manner by computer programs such as the application 30. The OS 40 includes a system call 41, a file system 42, a block device 43, and a device driver 44.

The system call 41 is an interface in the software meant for using the functions of the kernel of the OS 40, and functions as an interface between the kernel and the application 30.

The file system 42 is a system for managing the data, which is stored in a memory device (in the first embodiment, in the SSD 17), according to a predetermined management method.

The block device 43 is a device that, during input-output of the data with respect to the memory device (in the first embodiment, the SSD 17), performs input-output of sets of data of predetermined size, as well as enables random accessing.

The device driver 44 is a driver that controls the storage accessing unit 16, and implements input-output of data with respect to the SSD 17. The device driver 44 includes an access control module 441, a counting module 442, a determining module 443, and a deleting module 444.

The access control module 441 is a software module for implementing the function of issuing a data access request to the storage accessing unit 16 for the purpose of data reading, data writing, or data deletion.

The counting module 442 is a software module for implementing the function of a counter 442a (described later). The determining module 443 is a software module for implementing the function of a determination processor 443a (described later). The deleting module 444 is a software module for implementing the function of a deleter 444a (described later).

Meanwhile, the configuration of software modules of the device driver 44 is not limited to the configuration illustrated in FIG. 2. That is, as long as it is possible to implement the function of each module, software modules can be configured in any manner.

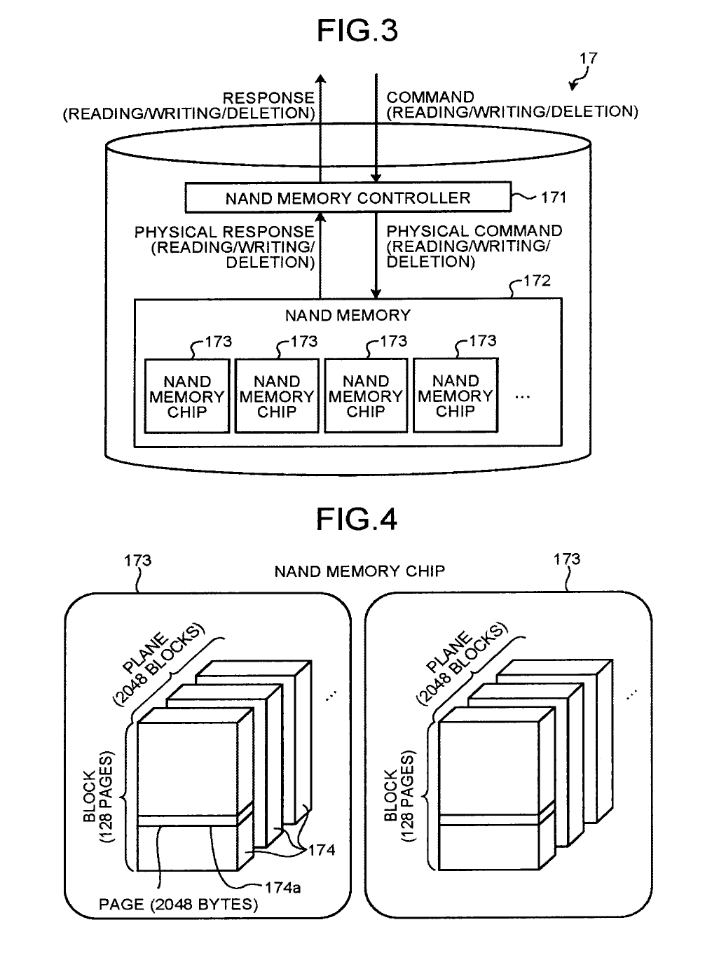

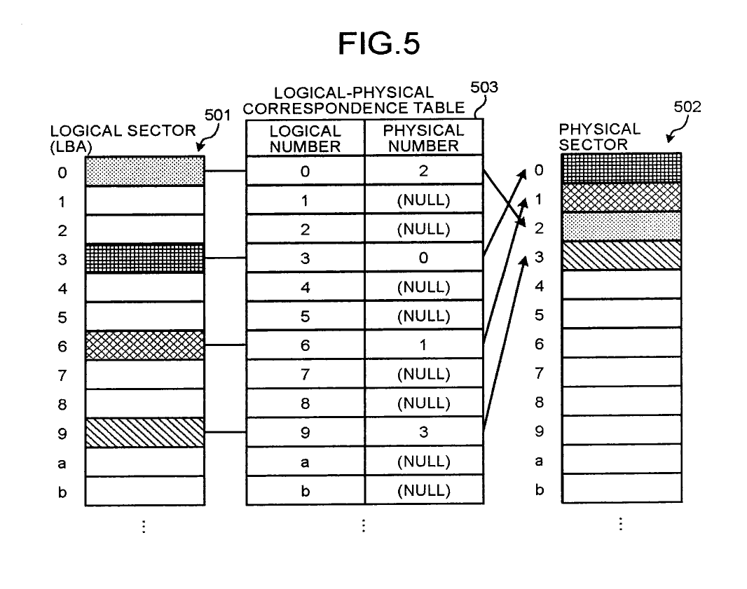

FIG. 3 is a configuration diagram of an SSD. FIG. 4 is a configuration diagram of a NAND memory chip. FIG. 5 is a diagram for explaining conversion between logical sectors and physical sectors. Thus, explained below with reference to FIGS. 3 to 5 is a brief summary of the configuration of the SSD 17.

As illustrated in FIG. 3, the SSD 17 includes a NAND memory controller 171 and a NAND memory 172.

The NAND memory controller 171 is a device that accesses the NAND memory 172 according to a command for writing, reading, or deletion received from the storage accessing unit 16. More particularly, the NAND memory controller 171 accesses the NAND memory 172 using a physical command for reading, writing, or deletion according to the command received from the storage accessing unit 16, and receives a physical response from the NAND memory 172. In that case, the physical response against a physical command for reading includes the target data for reading. Moreover, the physical response against a physical command for writing or deletion includes a notification of completion of writing or deletion of the data. Then, the NAND memory controller 171 sends, to the storage accessing unit 16, a response to the physical response that is received from the NAND memory 172.

The NAND memory 172 represents the main body of the NAND-type flash memory in which the data is stored, and is configured with a plurality of NAND memory chips 173.

As illustrated in FIG. 4, each NAND memory chip 173 includes a plurality of (for example, 2048) blocks 174 each of which is a collection of memory elements, and constitutes a single plane. Each block 174 is configured with a plurality of pages 174a formed by subdividing the collection of memory elements. For example, as illustrated in FIG. 4, each block 174 is configured with 128 pages 174a, each of which represents a memory element aggregate in which 2048 bytes (2 kilobytes) of data can be stored. Meanwhile, in FIG. 4 is illustrated an example in which each NAND memory chip 173 includes a single plane configured with a plurality of blocks 174. However, that is not the only possible case. That is, each NAND memory chip 173 may include two or more planes.

In the case of reading the data from the NAND memory chips 173, the NAND memory controller 171 performs reading on a page-by-page basis (in the example illustrated in FIG. 4, performs reading of 2 kilobytes of data at a time). On the other hand, in the case of writing the data in the NAND memory chips 173 or deleting the data from the NAND memory chips 173, the NAND memory controller 171 performs writing or deletion on a block-by-block basis (in the example illustrated in FIG. 4, performs writing or deletion for 128 pages at a time). Moreover, the NAND memory controller 171 cannot overwrite data in the NAND memory chip 173. That is, in order to overwrite data in the NAND memory chip 173, the NAND memory controller 171 needs to once delete (erase) the data in the target block. Only then, the NAND memory controller 171 can perform block-by-block data writing.

In practice, the NAND memory controller 171 provides the external storage accessing unit 16 with a data accessing function in units of sectors each representing a set of data. That is, the NAND memory controller 171 provides the external storage accessing unit 16 with an accessing function for data reading, data writing, or data deletion in units of sectors. As a result, the storage accessing unit 16 can access the NAND memory 172 via the NAND memory controller 171 for the purpose of data reading, data writing, or data deletion in units of sectors. That is, as a result of the control performed by the NAND memory controller 171 regarding page-by-page data reading and block-by-block writing and deletion, the storage accessing unit 16 becomes able to perform sector-by-sector data accesses. Meanwhile, a sector represents, for example, 512 bytes or 4 kilobytes, and is not always equal to the capacity of the pages 174a.

In order to provide the storage accessing unit 16 with sector-by-sector data accesses, the NAND memory controller 171 performs conversion between logical sectors 501 and physical sectors 502 (memory areas, first memory areas) as illustrated in FIG. 5. A logical sector is also called logical block addressing (LBA). More particularly, the NAND memory controller 171 includes a logical-physical correspondence table 503 (correspondence information) in which numbers assigned to the logical sectors 501 (hereinafter, called logical numbers) and numbers assigned to the physical sectors 502 (hereinafter, called physical numbers) are held in a corresponding manner. As illustrated in FIG. 5, the logical-physical correspondence table 503 is a table in which the logical numbers and the physical numbers are associated with each other. The logical sectors 501 are virtual sectors targeted for data accessing by the storage accessing unit 16 for the purpose of reading, writing, or deletion of data. That is, the storage accessing unit 16 performs data accessing by specifying the logical sector 501 having a particular logical number. On the other hand, the physical sectors 502 are sectors serving as actual memory areas that are actually assigned in the NAND memory 172. For example, in the example illustrated in FIG. 5, assume that the storage accessing unit 16 issues a command to the NAND memory controller 171 for reading the data from the logical sector 501 having the logical number “3”. In that case, the NAND memory controller 171 refers to the logical-physical correspondence table 503, converts the logical number “3” into the physical number “0”, reads the data from the physical sector 502 having the physical number “0”, and sends the read data as the response to the storage accessing unit 16. Meanwhile, the timing at which the NAND memory controller 171 writes the data in the physical sector 502 or deletes the data from the physical sector 502 in response to a physical command is dependent on the control method implemented in the NAND memory controller 171.

Moreover, in the example illustrated in FIG. 5, when no data is written in a particular logical sector 501, no corresponding physical sector 502 is assigned. In that case, the logical number of the corresponding physical sector 502 is expressed as “null”. Meanwhile, in the example illustrated in FIG. 5, the logical sectors 501 and the physical sectors 502 correspond on a one-on-one basis. However, that is not the only possible case. Alternatively, for example, a single logical number can have a plurality of physical sectors 502 corresponding thereto, or the logical sectors 501 and the physical sectors 502 can have different data granularities.

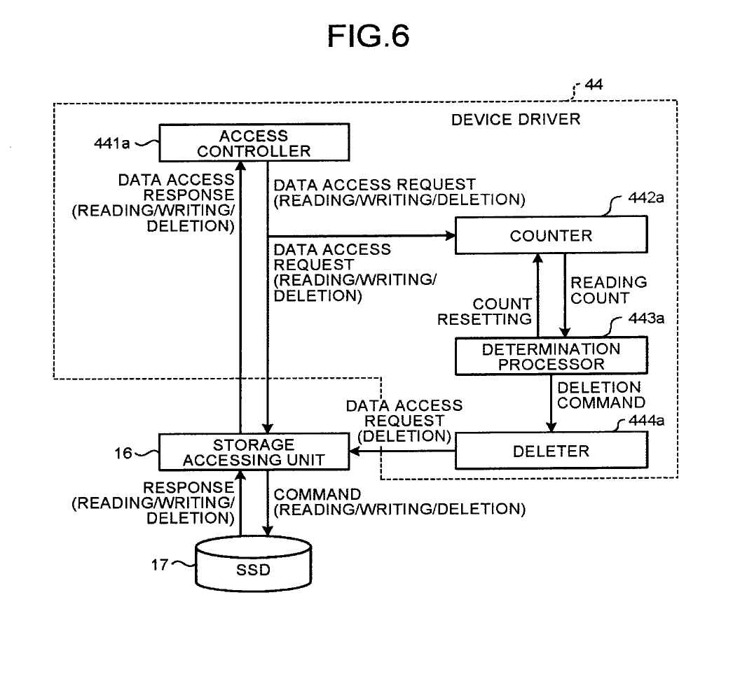

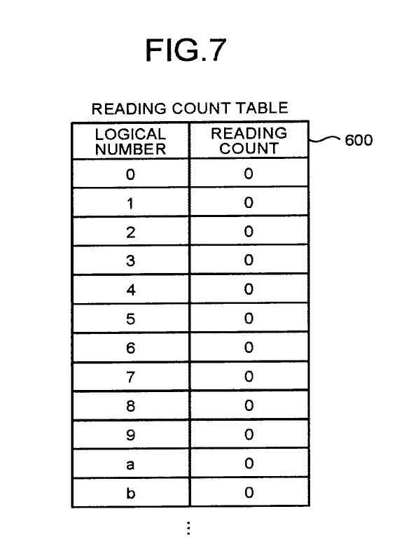

FIG. 6 is a diagram illustrating an exemplary functional block configuration of the information processing device according to the first embodiment. FIG. 7 is a diagram illustrating an exemplary reading count table according to the first embodiment. Thus, explained below with reference to FIG. 7 is a functional block configuration of the information processing device 10 according to the first embodiment.

As described above, in each NAND memory 172 configured with a NAND memory and including a plurality of NAND memory chips 173, a phenomenon called read disturb phenomenon occurs during which the stored data gets damaged as the data reading count mounts. During the read disturb phenomenon, in a NAND memory, if the page 174a at a particular position of one of the blocks 174 illustrated in FIG. 4 is read; the load also gets applied to the pages 174a at the other positions in the same block 174, and the data stored at the pages not at the position of the directly-read page also gets damaged. When the reading count becomes equal to or greater than an allowable count, an error occurs in the data stored in the concerned portion. Hence, the NAND memory controller 171 performs an error recovering operation having a large operational load, such as a restoration algorithm for data restoration (for example, an algorithm based on the Reed-Solomon method). For that reason, while reading the data from the block in which the read disturb phenomenon has occurred, the reading time increases thereby resulting in an increase in the delay. Moreover, unless deletion of data and rewriting of data is performed with respect to the block in which the read disturb phenomenon has occurred, the read disturb phenomenon is not resolved. In that regard, in the first embodiment, in all of the blocks 174 that constitute the NAND memory 172, the control is performed in such a way that data is deleted while the reading count is still smaller than the number of times for which the read disturb phenomenon has occurred.

As illustrated in FIG. 6, the device driver 44 is loaded in the RAM 13 and executed by the CPU 11. As a result, the device driver 44 functions as an access controller 441a, the counter 442a, the determination processor 443a, and the deleter 444a.

The access controller 441a is a processing unit that, according to a request from higher-level software (more particularly, the block device 43), sends a data access request (an access request) for reading, writing, or deletion to the storage accessing unit 16. Moreover, the access controller 441a receives, from the storage accessing unit 16, a data access response to the data access request. The access controller 441a is implemented using the access control module 441 of the device driver 44 that is executed by the CPU 11. A data access request includes information about a logical number indicating the logical number of the logical sector 501 to be accessed in the NAND memory controller 171. Moreover, a data access request for writing includes the data to be written in the logical sector 501 of the NAND memory controller 171. Furthermore, the data access response to a data access request for reading includes the data read from the SSD 17 by the storage accessing unit 16. Moreover, the data access response to a data access request for writing or deletion includes a notification of completion of writing of data in or deletion of data from the SSD 17 by the storage accessing unit 16.

The counter 442a is a processing unit that receives a data access request output by the access controller 441a and controls, in a reading count table 600 illustrated in FIG. 7, the reading count corresponding to the logical number specified in the data access request. When the received data access request is a reading request; the counter 442a counts up (increments), in the reading count table 600, the reading count corresponding to the logical number specified in the data access request. On the other hand, when the received data access request is a writing request or a deletion request; the counter 442a resets, in the reading count table 600, zero as the reading count corresponding to the logical number specified in the data access request. In this way, the counter 442a holds, in the reading count table 600, the cumulative reading count of the physical sector 502 that corresponds to the logical sector 501 having the logical number specified in the data access request. Moreover, the counter 442a sends the information about the counted-up reading count to the determination processor 443a. Furthermore, when a count resetting request is received from the determination processor 443a, the counter 442a resets zero as the reading count of the concerned logical sector 501 in the reading count table 600. Meanwhile, the counter 442a is implemented using the counting module 442 of the device driver 44 that is executed by the CPU 11. Moreover, while the information processing device 10 is in the shutdown state, the reading count table 600 is stored in the SSD 17. When the information processing device 10 is activated, the reading count table 600 is read from the SSD 17 into the RAM 13, thereby becoming updatable at high speeds. When the information processing device 10 is shutdown from the activated state, the reading count table 600 is stored in the SSD 17 with the existing reading count held therein.

The determination processor 443a is a processing unit that determines whether or not the reading count received from the counter 442a is equal to or greater than a predetermined upper limit count (a predetermined count). If the reading count is equal to or greater than the predetermined upper limit count, then the determination processor 443a sends, to the deleter 444a, a deletion command for deleting the data from the concerned logical sector 501; and sends, to the counter 442a, a count resetting request for resetting, in the reading count table 600, the reading count of the concerned logical sector 501. The determination processor 443a is implemented using the determining module 443 of the device driver 44 that is executed by the CPU 11. Meanwhile, the predetermined upper count limit represents, for example, the count calculated according to Equation (1) given below.

(upper limit count)=(allowable reading count in blocks specific to NAND memory)/(number of pages in one block) (1)

As a result of setting the count calculated according to Equation (1) as the upper limit count, at least the reading count of the same data in the same block can be kept equal to or smaller than the allowable count. Therefore, it becomes possible to hold down the occurrence of the read disturb phenomenon.

Meanwhile, the upper limit count for reading is not limited to the count calculated according to Equation (1). Alternatively, even if a value smaller than the count calculated according to Equation (1) is set as the upper limit count, it still becomes possible to achieve the same effect. Moreover, the upper limit count for reading a block as calculated according to Equation (1) does not imply that, when reading is performed for more number of times than the upper limit count, the read disturb phenomenon invariably occurs. That is, it is to be noted that the upper limit count for reading serves only as a rough indication for holding down the occurrence of the read disturb phenomenon.

The deleter 444a is a processing unit that, when a deletion command is received from the determination processor 443a, sends, to the storage accessing unit 16, a data access request for deleting the data from the logical sector 501 having the logical number specified in the deletion command. The deleter 444a is implemented using the deleting module 444 of the device driver 44 that is executed by the CPU 11.

The storage accessing unit 16 follows the data access request for reading, writing, or deletion that is received from the access controller 441a, and accordingly sends a command to the SSD 17 (more particularly, to the NAND memory controller 171). Then, the storage accessing unit 16 receives, from the SSD 17, a response to the command sent to the SSD 17. In this case, the response to a command for reading includes the target data for reading. Moreover, the response to a command for writing or deletion includes a notification of completion of writing of data in or deletion of data from the SSD 17. Meanwhile, when a data access request for deletion is received from the deleter 444a, the storage accessing unit 16 sends, to the SSD 17, a command for deleting the data from the logical sector 501 having the logical number that is specified in the data access request.

Herein, the access controller 441a, the counter 442a, the determination processor 443a, and the deleter 444a illustrated in FIG. 6 represent only a conceptual illustration of the functions, and the configuration is not limited to that example.

Moreover, the access controller 441a, the counter 442a, the determination processor 443a, and the deleter 444a illustrated in FIG. 6 need not be software in the form of computer programs; and at least some of them can be implemented using hardware circuitry. For example, when at least some of the access controller 441a, the counter 442a, the determination processor 443a, and the deleter 444a are implemented using hardware circuitry, they can be installed in the storage accessing unit 16.

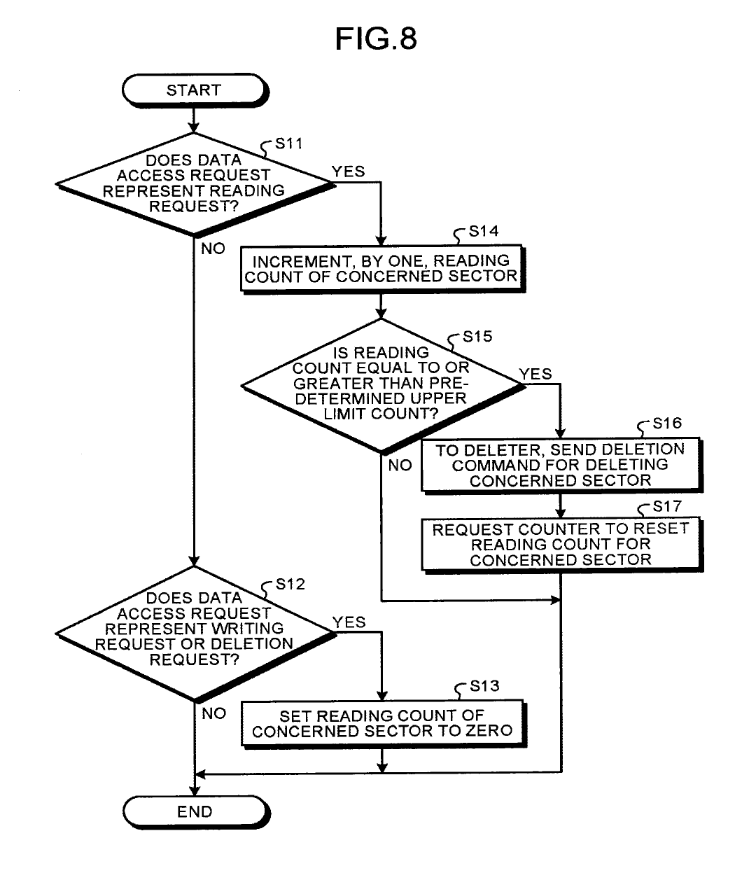

FIG. 8 is a flowchart for explaining the operations performed in response to a data access request according to the first embodiment. Thus, explained below with reference to FIG. 8 are the operations performed when a data access request is received from higher-level software (more particularly, the block device 43). Firstly, the access controller 441a of the device driver 44 receives a data access request for reading, writing, or deletion from higher-level software, and accordingly sends a data access request to the storage accessing unit 16.

Step S11

The counter 442a of the device driver 44 receives the data access request from the access controller 441a. Then, the counter 442a determines whether or not the received data access request is a data reading request. If the received data access request is not a data reading request (No at Step S11), then the system control proceeds to Step S12. However, when the received data access request is a data reading request (Yes at Step S11), the system control proceeds to Step S14.

Step S12

The counter 442a determines whether or not the received data access request is a data writing request or a data deletion request. If the received data access request is a data writing request or a data deletion request (Yes at Step S12), then the system control proceeds to Step S13. However, if the received data access request is neither a data writing request nor a data deletion request (No at Step S12), then it marks the end of the operations.

Step S13

If the received data access request is a data writing request or a data deletion request, then the counter 442a resets, in the reading count table 600, zero as the reading count corresponding to the logical number specified in the data access request. That is because of the following reason. For example, when the data access request is a data writing request, the NAND memory controller 171 writes the data in the logical sector 501 having the logical number specified in the data access request, assigns the physical number corresponding to that logical number in the logical-physical correspondence table 503, and newly writes data in the physical sector 502 having that physical number. Hence, the data written in the physical sector 502 has the reading count of zero. When the data accessing unit is a data deletion request, the NAND memory controller 171 deletes the data from the logical sector 501 having the logical number specified in the data access request, and the assignment of the physical number corresponding to that logical number is cleared (set to “null”) in the logical-physical correspondence table 503. It marks the end of the operations.

Step S14

When the received data access request is a data reading request; the counter 442a counts up (increments), in the reading count table 600, the reading count corresponding to the logical number specified in the data access request. Moreover, the counter 442a sends the information about the counted-up reading count to the determination processor 443a of the device driver 44. Then, the system control proceeds to Step S15.

Step S15

The determination processor 443a determines whether or not the reading count received from the counter 442a is equal to or greater than a predetermined upper limit count. If the reading count is equal to or greater than the predetermined upper limit count (Yes at Step S15), then the system control proceeds to Step S16. However, if the reading count is smaller than the predetermined upper limit count (No at Step S15), it marks the end of the operations.

Step S16

When the reading count is equal to or greater than the predetermined upper limit count, the determination processor 443a sends, to the deleter 444a, a deletion command for deleting the data from the logical sector 501 having the logical number corresponding to the reading count in the reading count table 600. Upon receiving the deletion command from the determination processor 443a, the deleter 444a sends, to the storage accessing unit 16, a data access request for deleting the data from the logical sector 501 having the logical number specified in the deletion command. Upon receiving the data access request for deletion from the deleter 444a, the storage accessing unit 16 sends, to the NAND memory controller 171 of the SSD 17, a command for deleting the data from the logical sector 501 having the logical number specified in the data access request. Upon receiving the deletion command from the storage accessing unit 16, the NAND memory controller 171 makes use of a physical command and deletes the data from the logical sector 501 having the logical number specified in the command. Then, at a predetermined timing, the NAND memory controller 171 deletes the data from the physical sector 502 (deletes first data) corresponding to the logical sector from which the data was deleted. The system control then proceeds to Step S17.

Step S17

Moreover, the determination processor 443a sends, to the counter 442a, a count resetting request for resetting, in the reading count table 600, the reading count corresponding to the logical number of the logical sector 501 from which the data is to be deleted. Upon receiving the count resetting request from the determination processor 443a, the counter 442a resets, in the reading count table 600, zero as the reading count corresponding to the logical number specified in the count resetting request. It marks the end of the operations.

In this way, the counter 442a of the device driver 44 receives a data access request that is sent by the access controller 441a to the storage accessing unit 16. If the data access request is determined to be a reading request, then the counter 442a counts up the reading count corresponding to the logical number specified in the data access request. When the counted-up reading count is determined to be equal to or greater than a predetermined upper limit count; the determination processor 443a sends, to the deleter 444a, a deletion command for deleting the data corresponding to the reading count in the SSD 17. Then, according to the deletion command, the deleter 444a ensures deletion of the data corresponding to the reading count in the SSD 17 using a deletion access request for deleting the data corresponding to the reading count in the SSD 17. As a result, at least the number of times of reading the data from the same memory area in a NAND memory can be kept equal to or smaller than the allowable count. Hence, it becomes possible to hold down the occurrence of the read disturb phenomenon. Thus, in the case of reading data from the SSD 17 which serves as the memory device, it becomes possible to avoid an error recovering operation for the purpose of restoring the data. Consequently, it is possible to hold down an increase in the reading time.

Moreover, when it is determined that the counted-up reading count is equal to or greater than the predetermined upper limit count; the determination processor 443a sends, to the counter 442a, a count resetting request for resetting, in the reading count table 600, the reading count corresponding to the logical number of the logical sector 501 from which the data is to be deleted. According to the count resetting request, the counter 442a resets, in the reading count table 600, zero as the reading count corresponding to the logical number specified in the count resetting request. As a result, regarding the data written in the physical sector 502 that is newly assigned with a physical number corresponding to a logical number in the logical-physical correspondence table 503, it becomes possible to keep the reading count anew.

Furthermore, by keeping the predetermined upper limit count to be equal to or smaller than the count calculated according to Equation (1), at least the reading count of the data in the same memory area in the NAND memory can be kept equal to or smaller than the allowable count. Therefore, the occurrence of the read disturb phenomenon can be held down with a high degree of certainty. Consequently, it is possible to hold down an increase in the reading time taken for reading the data from the SSD 17.

### Modification Example of First Embodiment

Regarding an information processing device according to a modification example, the explanation is given with the focus on the differences with the information processing device 10 according to the first embodiment. The information processing device according to the modification example has an identical hardware configuration to the information processing device 10 according to the first embodiment. Moreover, regarding the software configuration of the information processing device according to the modification example, a device driver 45 is substituted for the device driver 44 in the software configuration of the information processing device 10 illustrated in FIG. 2 according to the first embodiment.

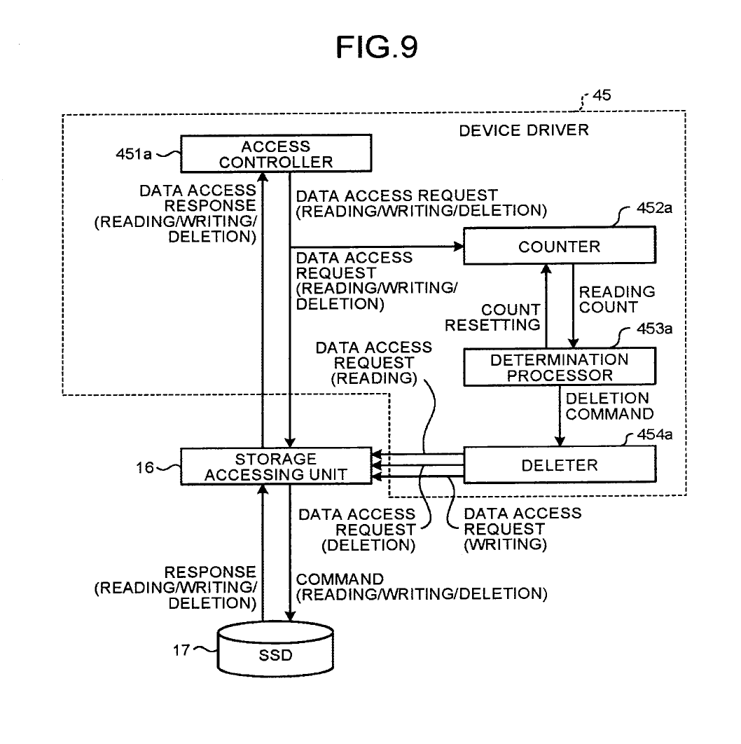

FIG. 9 is a diagram illustrating an exemplary functional block configuration of an information processing device according to the modification example of the first embodiment. Thus, explained below with reference to FIG. 9 is a functional block configuration of the information processing device according to the modification example with the focus on the differences with the functional block configuration of the information processing device 10 according to the first embodiment.

As illustrated in FIG. 9, the device driver 45 is loaded in the RAM 13 and executed by the CPU 11. As a result, the device driver 45 functions as an access controller 451a, a counter 452a, a determination processor 453a, and a deleter 454a. Herein, the access controller 451a, the counter 452a, and the determination processor 453a have the functions identical to the access controller 441a, the counter 442a, and the determination processor 443a, respectively, illustrated in FIG. 6 according to the first embodiment.

The deleter 454a is a processing unit that, when a deletion command is received from the determination processor 453a, sends, to the storage accessing unit 16, a data access request for reading the data of the physical sector 502 having the physical number corresponding to the logical number that is specified in the deletion command. Moreover, the deleter 454a sends to the storage accessing unit 16 a data access request for deleting the data from the logical sector 501 having the logical number specified in the deletion command. Then, the deleter 454a sends, to the storage accessing unit 16, a data access request for writing the read data in the logical sector 501 having the logical number specified in the deletion command.

The storage accessing unit 16 follows the data access request for reading, writing, or deletion that is received from the access controller 451a, and accordingly sends a command to the SSD 17 (more particularly, to the NAND memory controller 171). Then, the storage accessing unit 16 receives, from the SSD 17, a response to the command sent to the SSD 17.

Meanwhile, when a data access request for reading is received from the deleter 454a; the storage accessing unit 16 sends, to the SSD 17, a command for reading the data of the logical sector 501 having the logical number that is specified in the data access request. Alternatively, when a data access request for deletion is received from the deleter 454a; the storage accessing unit 16 sends, to the SSD 17, a command for deleting the data from the logical sector 501 having the logical number that is specified in the data access request. Still alternatively, when a data access request for writing is received from the deleter 454a; the storage accessing unit 16 sends, to the SSD 17, a command for writing the data in the logical sector 501 having the logical number that is specified in the data access request.

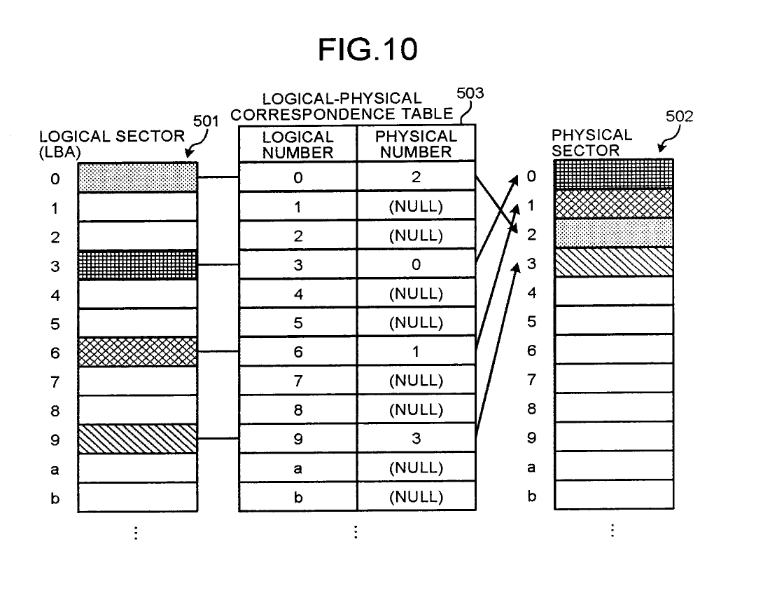

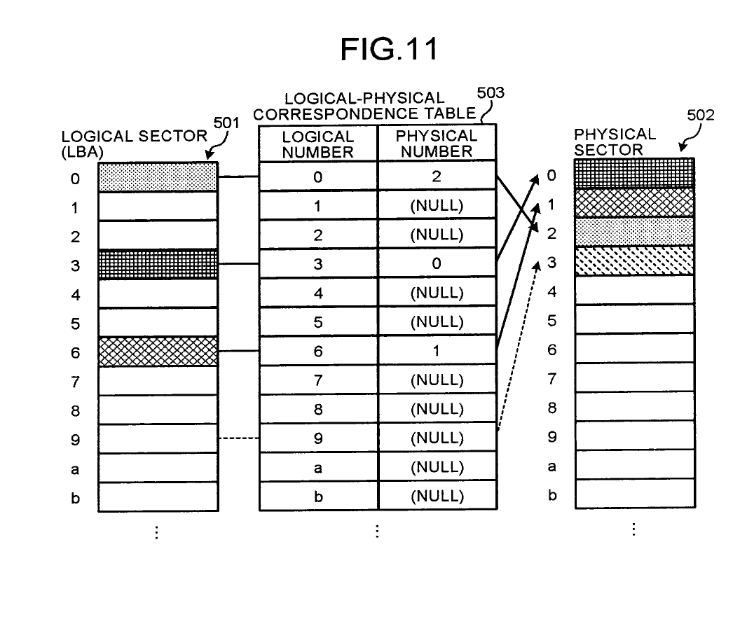

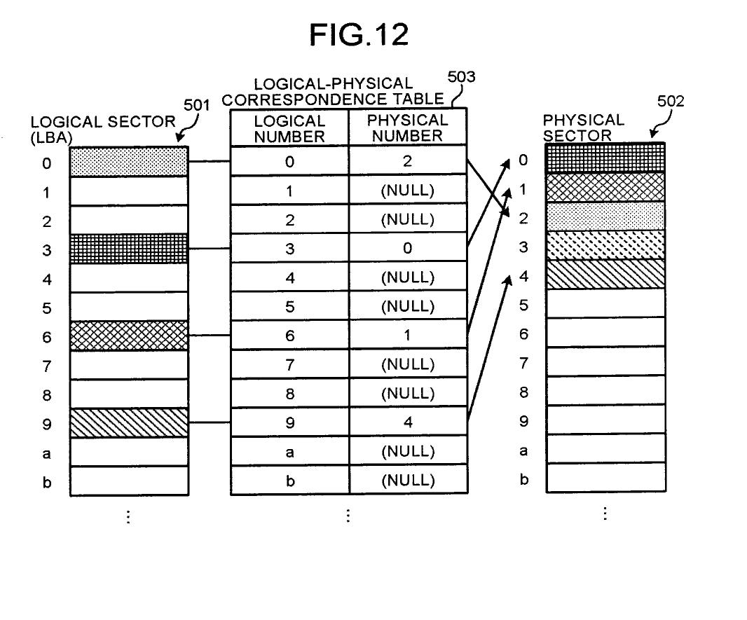

FIG. 10 is a diagram illustrating exemplary states of the logical sectors and the physical sectors before the data is deleted. FIG. 11 is a diagram illustrating exemplary states of the logical sectors and the physical sectors after the data is deleted. FIG. 12 is a diagram illustrating exemplary states of the logical sectors and the physical sectors after the data is written. Thus, explained below with reference to FIG. 8 and FIGS. 10 to 12 are the operations performed when a data access request is received from higher-level software (more particularly, the block device 43). Herein, the explanation is given with the focus on the differences with the first embodiment. During the information processing according to the modification example, the operations performed at Steps S11 to S15 and Step S17 illustrated in FIG. 8 are identical to the operations performed in the information processing device 10 according to the first embodiment.

Step S16

When the reading count is equal to or greater than the predetermined upper limit count; the determination processor 453a sends, to the deleter 454a of the device driver 45, a deletion command for deleting the data from the logical sector 501 having the logical number corresponding to the reading count in the reading count table 600. Upon receiving the deletion command from the determination processor 453a; the deleter 454a sends, to the storage accessing unit 16, a data access request for reading the data of the physical sector 502 having the physical number corresponding to the logical number specified in the deletion command. Then, as a response to the data access request, the deleter 454a receives a data access response (not illustrated) from the storage accessing unit 16 and obtains the data read from the physical sector 502 having the physical number corresponding to the logical number specified in the deletion command.

For example, as illustrated in FIG. 10, the deleter 454a receives a data access response including the target data for deletion read from the physical sector 502 having the physical number “3” that is obtained by conversion of the logical number “9”, which is specified in the deletion command, using the logical-physical correspondence table 503.

Then, the deleter 454a sends, to the storage accessing unit 16, a data access request for deleting the data from the logical sector 501 having the logical number specified in the deletion command. Upon receiving the data access request for deletion from the deleter 454a; the storage accessing unit 16 sends, to the NAND memory controller 171 of the SSD 17, a command for deleting the data from the logical sector 501 having the logical number specified in the data access request. Upon receiving the deletion command from the storage accessing unit 16, the NAND memory controller 171 makes use of a physical command and deletes the data from the logical sector 501 having the logical number specified in the command. Then, at a predetermined timing, the NAND memory controller 171 deletes the data from the physical sector 502 corresponding to the logical sector from which the data was deleted.

For example, as illustrated in FIG. 11, the NAND memory controller 171 makes use of a physical command and deletes the data from the logical sector 501 having the logical number specified in the command that is received from the storage accessing unit 16. Then, the NAND memory controller 171 clears (writes “null” as) the assignment of the physical number corresponding to the logical number “9” in the logical-physical correspondence table 503. As a result, the correspondence relationship between the logical number and the physical number is cleared, and the physical sector 502 having the physical number “3” is not accessed (read). Moreover, at a predetermined timing, the NAND memory controller 171 deletes the data from the physical sector 502 having the physical number “3”.

Then, the deleter 454a sends, to the storage accessing unit 16, a data access request for writing the obtained data in the logical sector 501 having the logical number specified in the deletion command. Upon receiving the data access request for writing from the deleter 454a; the storage accessing unit 16 sends, to the NAND memory controller 171 of the SSD 17, a command for writing the obtained data in the logical sector 501 having the logical number specified in the data access request. Upon receiving the writing command from the storage accessing unit 16, the NAND memory controller 171 makes use of a physical command and writes the data included in the command (writes second data) in the logical sector 501 having the logical number specified in the writing command. Then, at a predetermined timing, the NAND memory controller 171 writes the concerned data in the physical sector 502 that is newly associated to the logical sector 501 in which the data was written. As a result, the data corresponding to the reading count, which has become equal to or greater than the predetermined upper limit count, gets copied in the newly-associated physical sector 502.

For example, as illustrated in FIG. 12, the NAND memory controller 171 makes use of a physical command and writes the data, which is included in the command received from the storage accessing unit 16, in the logical sector 501 having the logical number “9” specified in the command. Then, the NAND memory controller 171 assigns, in the logical-physical correspondence table 503, another new physical number “4” corresponding to the logical number “9”. Subsequently, at a predetermined timing, the NAND memory controller 171 writes the data, which was written in the logical sector 501 having the logical number “9”, in the physical sector 502 having the physical number “4” corresponding to the logical number “9”.

In this way, in the first embodiment, regarding the data that corresponds to the reading count equal to or greater than the predetermined reading count and that is stored in the SSD 17, the only operation performed is deletion. In contrast, in the modification example, the target data for deletion is read and obtained and is copied in the newly-assigned physical sector 502 that is different from the physical sector 502 from which the data is to be deleted. As a result, in addition to achieving the effect of the first embodiment, not only the data is deleted before the occurrence of the read disturb phenomenon, but also the concerned data is written (copied) in the newly-assigned physical sector 502. As a result, it becomes possible to retain that data.

Meanwhile, the logical sector 501 that is copied can remain the same, and the reading count for that logical sector 501 is reset. Therefore, in the case of reading the data that is copied in the newly-assigned physical sector 502 corresponding to the concerned logical sector 501, reading can be done based on the same logical number as the target logical number for deletion, and the concerned data can be continually used.

### Second Embodiment

Regarding an information processing device according to a second embodiment, the explanation is given with the focus on the differences with the information processing device 10 according to the first embodiment. The information processing device according to the second embodiment has an identical hardware configuration to the information processing device 10 illustrated in FIG. 1 according to the first embodiment.

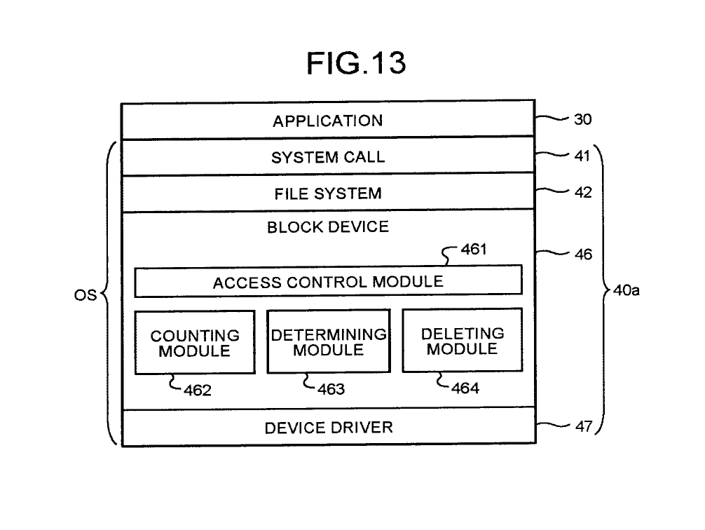

FIG. 13 is a diagram illustrating an exemplary software configuration of the information processing device according to the second embodiment. Thus, explained below with reference to FIG. 13 is a software configuration of the information processing device according to the second embodiment. Herein, the system call 41 and the file system 42 are identical to the system call 41 and the file system 42 in the software configuration of the information processing device 10 illustrated in FIG. 2 according to the first embodiment. Hence, the system call 41 and the file system 42 are referred to by the same reference numerals, and the relevant explanation is not repeated.

As illustrated in FIG. 13, the software of the information processing device according to the second embodiment includes the application 30 and an OS 40a.

The application 30 is a computer program used for the purpose of performing a particular task. The application 30 is executed by the CPU 11 (see FIG. 1) in the OS 40a that is loaded in the RAM 13 (see FIG. 1).

The OS 40a represents the basic software equipped with the functions for basic management and control of the information processing device according to the second embodiment and equipped with the basic functions used in a shared manner by computer programs such as the application 30. The OS 40a includes the system call 41, the file system 42, a block device 46, and a device driver 47.

The block device 46 is a device that, during input-output of the data with respect to the memory device (the SSD 17 (see FIG. 1)), performs input-output of sets of data of predetermined size, as well as enables random accessing. The block device 46 includes an access control module 461, a counting module 462, a determining module 463, and a deleting module 464.

The access control module 461 is a software module for implementing the function of sending a data access request for reading, writing, or deletion to the device driver 47.

The counting module 462 is a software module for implementing the function of a counter 462a (described later). The determining module 463 is a software module for implementing the function of a determination processor 463a (described later). The deleting module 464 is a software module for implementing the function of a deleter 464a (described later).

Meanwhile, the configuration of software modules of the block device 46 is not limited to the configuration illustrated in FIG. 13. That is, as long as it is possible to implement the function of each module, software modules can be configured in any manner.

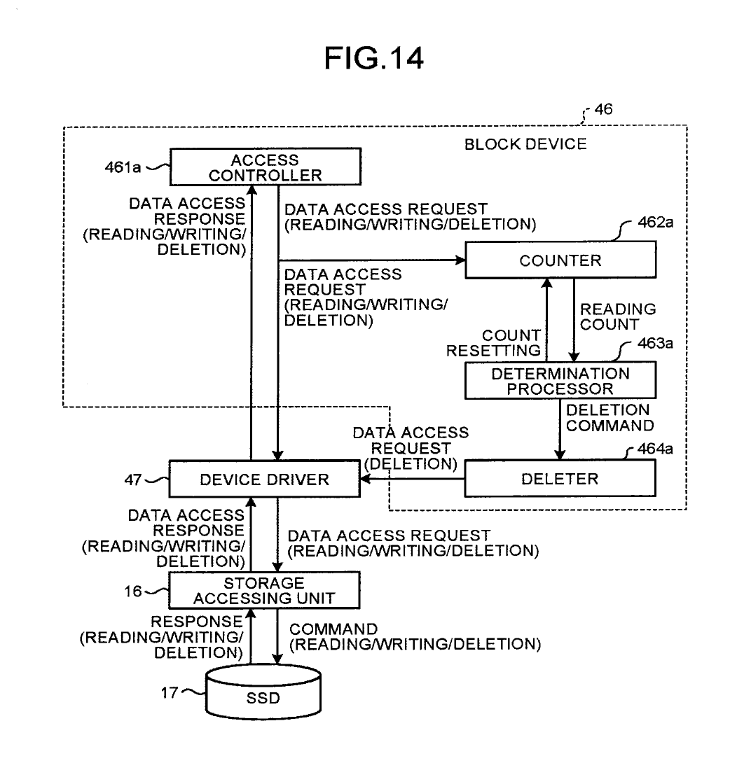

FIG. 14 is a diagram illustrating an exemplary functional block configuration of the information processing device according to the second embodiment. Thus, explained below with reference to FIG. 14 is the functional block configuration of the information processing device according to the second embodiment with the focus on the differences with the block configuration of the information processing device 10 according to the first embodiment.

As illustrated in FIG. 14, the block device 46 is loaded in the RAM and executed by the CPU 11. As a result, the block device 46 functions as an access controller 461a, the counter 462a, the determination processor 463a, and the deleter 464a.

The access controller 461a is a processing unit that, according to a request from higher-level software (more particularly, the file system 42), sends a data access request (an access request) for reading, writing, or deletion to the device driver 47. Moreover, the access controller 461a receives, from the device driver 47, a data access response to the data access request. The access controller 461a is implemented using the access control module 461 of the block device 46 that is executed by the CPU 11. A data access request includes information about a logical number indicating the logical number of the logical sector 501 to be accessed in the NAND memory controller 171. Moreover, a data access request for writing includes the data to be written in the logical sector 501 of the NAND memory controller 171. Furthermore, the data access response to a data access request for reading includes the data read from the SSD 17 by the storage accessing unit 16. Moreover, the data access response to a data access request for writing or deletion includes a notification of completion of writing of data in or deletion of data from the SSD 17 by the storage accessing unit 16.

The counter 462a is a processing unit that receives a data access request output by the access controller 461a and controls, in the reading count table 600 (see FIG. 7), the reading count corresponding to the logical number specified in the data access request. When the received data access request is a reading request; the counter 462a counts up (increments), in the reading count table 600, the reading count corresponding to the logical number specified in the data access request. On the other hand, when the received data access request is a writing request or a deletion request; the counter 462a resets, in the reading count table 600, zero as the reading count corresponding to the logical number specified in the data access request. In this way, the counter 462a holds, in the reading count table 600, the cumulative reading count of the physical sector 502 that corresponds to the logical sector 501 having the logical number specified in the data access request. Moreover, the counter 462a sends the information about the counted-up reading count to the determination processor 463a. Furthermore, when a count resetting request is received from the determination processor 463a, the counter 462a resets zero as the reading count of the concerned logical sector 501 in the reading count table 600. Meanwhile, the counter 462a is implemented using the counting module 462 of the block device 46 that is executed by the CPU 11.

The determination processor 463a is a processing unit that determines whether or not the reading count received from the counter 462a is equal to or greater than a predetermined upper limit count. If the reading count is equal to or greater than the predetermined upper limit count, then the determination processor 463a sends, to the deleter 464a, a deletion command for deleting the data from the concerned logical sector 501; and sends, to the counter 462a, a count resetting request for resetting, in the reading count table 600, the reading count of the concerned logical sector 501. The determination processor 463a is implemented using the determining module 463 of the block device 46 that is executed by the CPU 11. Meanwhile, the predetermined upper count limit represents, for example, the count calculated according to Equation (1) given earlier.

Herein, the upper limit count for reading is not limited to the count calculated according to Equation (1). Alternatively, even if a value smaller than the count calculated according to Equation (1) is set as the upper limit count, it still becomes possible to achieve the same effect.

The deletes 464a is a processing unit that, when a deletion command is received from the determination processor 463a, sends, to the device driver 47, a data access request for deleting the data from the logical sector 501 having the logical number specified in the deletion command. The deleter 464a is implemented using the deleting module 464 of the block device 46 that is executed by the CPU 11.

The device driver 47 follows the data access request for reading, writing, or deletion that is received from the access controller 461a, and accordingly sends a data access request to the storage accessing unit 16. Then, the device driver 47 receives, from the storage accessing unit 16, a data access response to the data access request sent to the storage accessing unit 16. The data access response to a data access request for reading includes the target data for reading. Moreover, the data access response to a data access request for writing or deletion includes a notification of completion of writing of data in or deletion of data from the SSD 17. Meanwhile, when a data access request for deletion is received from the deleter 464a; the device driver 47 sends, to the storage accessing unit 16, a data access request for deleting the data from the logical sector 501 having the logical number specified in the data access request.

The storage accessing unit 16 follows the data access request for reading, writing, or deletion that is received from the device driver 47, and accordingly sends a command to the SSD 17 (more particularly, to the NAND memory controller 171). Then, the storage accessing unit 16 receives, from the SSD 17, a response to the command sent to the SSD 17. In this case, the response to a command for reading includes the target data for reading. Moreover, the response to a command for writing or deletion includes a notification of completion of writing of data in or deletion of data from the SSD 17.

Meanwhile, the access controller 461a, the counter 462a, the determination processor 463a, and the deleter 464a illustrated in FIG. 14 represent only a conceptual illustration of the functions, and the configuration is not limited to that example.

Moreover, the access controller 461a, the counter 462a, the determination processor 463a, and the deleter 464a illustrated in FIG. 14 need not be software in the form of computer programs; and at least some of them can be implemented using hardware circuitry.

Explained below with reference to the flowchart illustrated in FIG. 8 are the operations performed when the block device 46 receives a data access request from higher-level software (more particularly, the file system 42). Firstly, the access controller 461a of the block device 46 receives a data access request for reading, writing, or deletion from higher-level software, and accordingly sends a data access request to the device driver 47.

Step S11

The counter 462a of the block device 46 receives the data access request from the access controller 461a. Then, the counter 462a determines whether or not the received data access request is a data reading request. If the received data access request is not a data reading request (No at Step S11), then the system control proceeds to Step S12. However, when the received data access request is a data reading request (Yes at Step S11), the system control proceeds to Step S14.

Step S12

The counter 462a determines whether or not the received data access request is a data writing request or a data deletion request. If the received data access request is a data writing request or a data deletion request (Yes at Step S12), then the system control proceeds to Step S13. However, if the received data access request is neither a data writing request nor a data deletion request (No at Step S12), then it marks the end of the operations.

Step S13

If the received data access request is a data writing request or a data deletion request; then the counter 462a resets, in the reading count table 600, zero as the reading count corresponding to the logical number specified in the data access request. It marks the end of the operations.

Step S14

When the received data access request is a data reading request; the counter 462a counts up (increments), in the reading count table 600, the reading count corresponding to the logical number specified in the data access request. Moreover, the counter 462a sends the information about the counted-up reading count to the determination processor 463a of the block device 46. Then, the system control proceeds to Step S15.

Step S15

The determination processor 463a determines whether or not the reading count received from the counter 462a is equal to or greater than a predetermined upper limit count. If the reading count is equal to or greater than the predetermined upper limit count (Yes at Step S15), then the system control proceeds to Step S16. However, if the reading count is smaller than the predetermined upper limit count (No at Step S15), then it marks the end of the operations.

Step S16

When the reading count is equal to or greater than the predetermined upper limit count; the determination processor 463a sends, to the deleter 464a of the block device 46, a deletion command for deleting the data from the logical sector 501 having the logical number corresponding to the reading count in the reading count table 600. Upon receiving the deletion command from the determination processor 463a; the deleter 464a sends, to the device driver 47, a data access request for deleting the data from the logical sector 501 having the logical number specified in the deletion command. Upon receiving the data access request for deletion from the deleter 464a; the device driver 47 sends, to the storage accessing unit 16, a command for deleting the data from the logical sector 501 having the logical number that is specified in the data access request. Upon receiving the deletion command from the device driver 47; the storage accessing unit 16 sends, to the NAND memory controller 171 of the SSD 17, a command for deleting the data from the logical sector 501 having the logical number specified in the data access request. Upon receiving the deletion command from the storage accessing unit 16, the NAND memory controller 171 makes use of a physical command and deletes the data from the logical sector 501 having the logical number specified in the command. Then, at a predetermined timing, the NAND memory controller 171 deletes the data from the physical sector 502 (deletes first data) corresponding to the logical sector from which the data was deleted. The system control then proceeds to Step S17.

Step S17

Moreover, the determination processor 463a sends, to the counter 462a, a count resetting request for resetting, in the reading count table 600, the reading count corresponding no the logical number of the logical sector 501 from which the data is to be deleted. Upon receiving the count resetting request from the determination processor 463a; the counter 462a resets, in the reading count table 600, zero as the reading count corresponding to the logical number specified in the count resetting request. It marks the end of the operations.

In this way, in the information processing device according to the second embodiment, regarding the access controller 441a, the counter 442a, the determination processor 443a, and the deleter 444a implemented by the device driver 44 according to the first embodiment, the equivalent functions are implemented not in the device driver but in the block device 46 positioned at a higher level. With such a configuration too, it becomes possible to achieve the same effect as the effect achieved in the first embodiment.

### Third Embodiment

Regarding an information processing device according to a third embodiment, the explanation is given with the focus on the differences with the information processing device 10 according to the first embodiment. The information processing device according to the third embodiment has an identical hardware configuration to the information processing device 10 illustrated in FIG. 1 according to the first embodiment.

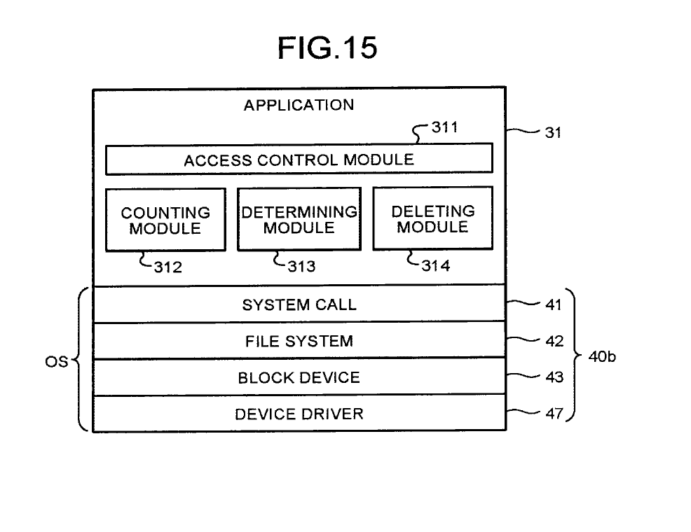

FIG. 15 is a diagram illustrating an exemplary software configuration of the information processing device according to the third embodiment. Thus, explained below with reference to FIG. 15 is a software configuration of the information processing device according to the third embodiment. Herein, the system call 41, the file system 42, and the block device 43 are identical to the system call 41, the file system 42, and the block device 43 in the software configuration of the information processing device 10 illustrated in FIG. 2 according to the first embodiment. Hence, the system call 41, the file system 42, and the block device 43 are referred to by the same reference numerals, and the relevant explanation is not repeated. Moreover, the device driver 47 is identical to the device driver 47 in the software configuration of the information processing device illustrated in FIG. 13 according to the second embodiment. Hence, the device driver 47 is referred to the same reference numeral and the relevant explanation is not repeated.

As illustrated in FIG. 15, the software of the information processing device according to the third embodiment includes an application 31 and an OS 40b.

The application 31 is a computer program used for the purpose of performing a particular task. The application 31 includes an access control module 311, a counting module 312, a determining module 313, and a deleting module 314. Moreover, the application 31 is executed by the CPU 11 (see FIG. 1) in the OS 40b that is loaded in the RAM 13 (see FIG. 1).

The access control module 311 is a software module for implementing the function of sending a system call for reading, writing, or deletion to the system call 41.

The counting module 312 is a software module for implementing the function of a counter 312a (described later). The determining module 313 is a software module for implementing the function of a determination processor 313a (described later). The deleting module 314 is a software module for implementing the function of a deleter 314a (described later).

Meanwhile, the configuration of software modules of the application 31 is not limited to the configuration illustrated in FIG. 15. That is, as long as it is possible to implement the function of each module, software modules can be configured in any manner.

The OS 40b represents the basic software equipped with the functions for basic management and control of the information processing device according to the third embodiment and equipped with the basic functions used in a shared manner by computer programs such as the application 31. The OS 40b includes the system call 41, the file system 42, the block device 43, and the device driver 47.

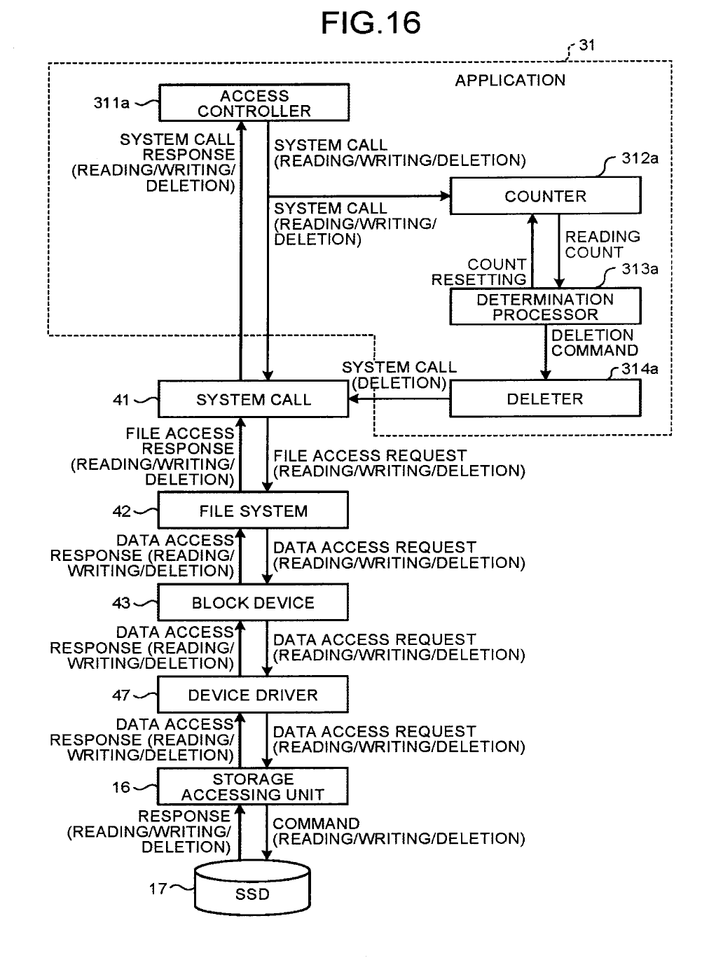

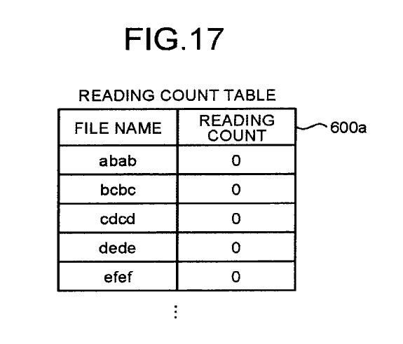

FIG. 16 is a diagram illustrating an exemplary functional block configuration of the information processing device according to the third embodiment. FIG. 17 is a diagram illustrating an exemplary reading count table according to the third embodiment. Thus, explained below with reference to FIGS. 16 and 17 is the functional block configuration of the information processing device according to the third embodiment with the focus on the differences with the block configuration of the information processing device 10 according to the first embodiment.

As illustrated in FIG. 16, the application 31 is loaded in the RAM and executed by the CPU 11. As a result, the application 31 functions as an access controller 311a, the counter 312a, the determination processor 313a, and the deleter 314a.

The access controller 311a is a processing unit that sends a system call (an access request) for reading, writing, or deletion to the system call 41. Moreover, the access controller 311a receives, from the system call 41, a system call response to the system call. The access controller 311a is implemented using the access control module 311 of the application 31 that is executed by the CPU 11. A system call includes file information indicating the file name of the file to be accessed. Moreover, a system call for writing includes the data to be written in the file. Furthermore, the system call response to a system call for reading includes the data of the file read from the SSD 17 by the storage accessing unit 16. Moreover, the system call response to a system call for writing or deletion includes a notification of completion of writing of file data in or deletion of file data from the SSD 17 by the storage accessing unit 16.

The counter 312a is a processing unit that receives a system call output by the access controller 311a and controls, in a reading count table 600a illustrated in FIG. 17, the reading count corresponding to the file name specified in the system call. When the received system call is a system call for reading; the counter 312a counts up (increments), in the reading count table 600a, the reading count corresponding to the file name specified in the system call. However, when the received system call is a system call for writing or deletion; the counter 312a resets, in the reading count table 600a, zero as the reading count corresponding to the file name specified in the system call. In this way, the counter 312a holds, in the reading count table 600a, the cumulative reading count of the file having the file name specified in the system call. Moreover, the counter 312a sends the information about the counted-up reading count to the determination processor 313a. Furthermore, when a count resetting request is received from the determination processor 313a, the counter 312a resets zero as the reading count of the concerned file name in the reading count table 600a. Meanwhile, the counter 312a is implemented using the counting module 312 of the application 31 that is executed by the CPU 11. Moreover, while the information processing device according to the third embodiment is in the shutdown state, the reading count table 600a is stored in the SSD 17. When the information processing device according to the third embodiment is activated, the reading count table 600a is read from the SSD 17 into the RAM 13, thereby becoming updatable at high speeds. When the information processing device is shutdown from the activated state, the reading count table 600a is stored in the SSD 17 with the existing reading count held therein.

Regarding the reading counts corresponding to the file names specified in the reading count table 600a; since the files having the concerned file names are stored in a divided manner in suitable physical sectors of the SSD 17, the reading counts either correspond to the physical sectors (memory areas, second memory areas) in which the data constituting the concerned files is stored or correspond to the logical sectors associated with the concerned physical sectors.

The determination processor 313a is a processing unit that determines whether or not the reading count received from the counter 312a is equal to or greater than a predetermined upper limit count. If the reading count is equal to or greater than the predetermined upper limit count; then the determination processor 313a sends, to the deleter 314a, a deletion command for deleting the data from the concerned file; and sends, to the counter 312a, a count resetting request for resetting, in the reading count table 600a, the reading count of the concerned file name. The determination processor 313a is implemented using the determining module 313 of the application 31 that is executed by the CPU 11. Meanwhile, the predetermined upper count limit represents, for example, the count calculated according to Equation (1) given earlier.

Herein, the upper limit count for reading is not limited to the count calculated according to Equation (1). Alternatively, even if a value smaller than the count calculated according to Equation (1) is set as the upper limit count, it still becomes possible to achieve the same effect.

The deleter 314a is a processing unit that, when a deletion command is received from the determination processor 313a, sends, to the system call 41, a system call for requesting deletion of the file having the file name specified in the deletion command. The deleter 314a is implemented using the deleting module 314 of the application 31 that is executed by the CPU 11.

The system call 41 follows the system call for reading, writing, or deletion that is received from the access controller 311a, and accordingly sends a filter access request to the file system 42. Then, the system call 41 receives, from the file system 42, a file access response to the file access request sent to the file system 42. The file access response to a file access request for reading includes the target file for reading. Moreover, the file access response to a file access request for writing or deletion includes a notification of completion of writing of data in or deletion of data from the SSD 17. Meanwhile, when a system call for deletion is received from the deleter 314a; the system call 41 sends, to the file system 42, a command for deleting the file having the file name specified in the system call.

The file system 42 follows the file access request for reading, writing, or deletion that is received from the system call 41, and accordingly sends a data access request to the block device 43. Then, the file system 42 receives, from the block device 43, a data access response to the data access request sent to the block device 43. In this case, the data access response to a data access request for reading includes the target data for reading. Moreover, the data access response to a data access request for writing or deletion includes a notification of completion of writing of data in or deletion of data from the SSD 17.

The block device 43 follows the data access request for reading, writing, or deletion that is received from the file system 42, and accordingly sends a data access request to the device driver 47. Then, the block device 43 receives, from the device driver 47, a data access response to the data access request sent to the device driver 47. In this case, the data access response to a data access request for reading includes the target data for reading. Moreover, the data access response to a data access request for writing or deletion includes a notification of completion of writing of data in or deletion of data from the SSD 17.

The device driver 47 follows the data access request for reading, writing, or deletion that is received from the block device 43, and accordingly sends a data access request to the storage accessing unit 16. Then, the device driver 47 receives, from the storage accessing unit 16, a data access response to the data access request sent to the storage accessing unit 16. In this case, the data access response to a data access request for reading includes the target data for reading. Moreover, the data access response to a data access request for writing or deletion includes a notification of completion of writing of data in or deletion of data from the SSD 17.

The storage accessing unit 16 follows the data access request for reading, writing, or deletion that is received from the device driver 47, and accordingly sends a command to the SSD 17 (more particularly, to the NAND memory controller 171). Then, the storage accessing unit 16 receives, from the SSD 17, a response to the command sent to the SSD 17. In this case, the response to a command for reading includes the target data for reading. Moreover, the response to a command for writing or deletion includes a notification of completion of writing of data in or deletion of data from the SSD 17.

Meanwhile, the access controller 311a, the counter 312a, the determination processor 313a, and the deleter 314a illustrated in FIG. 16 represent only a conceptual illustration of the functions, and the configuration is not limited to that example.

Moreover, the access controller 311a, the counter 312a, the determination processor 313a, and the deleter 314a illustrated in FIG. 16 need not be software in the form of computer programs; and at least some of them can be implemented using hardware circuitry.

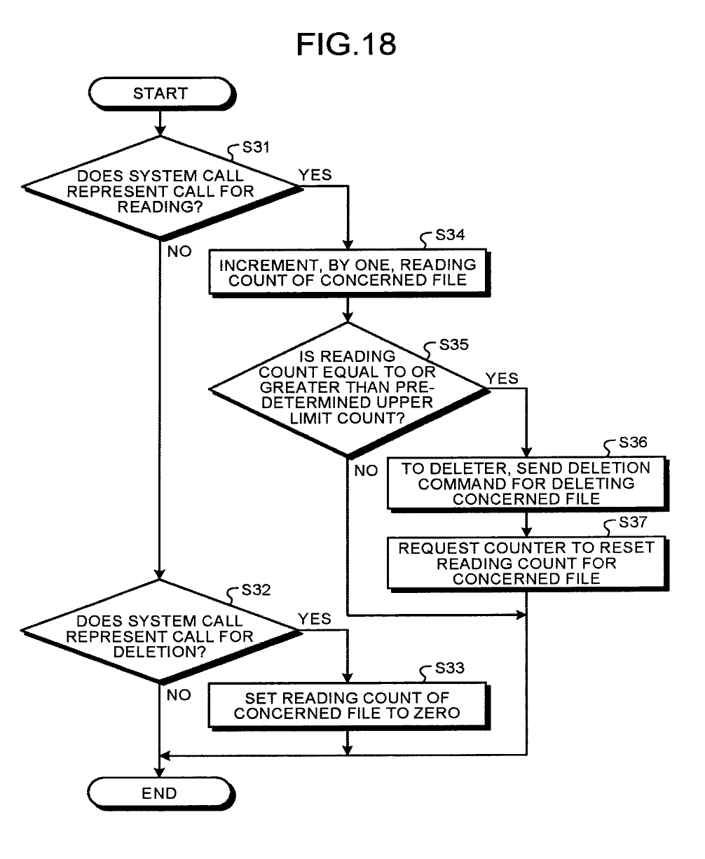

FIG. 18 is a flowchart for explaining the operations performed in response to a system call that is output from an application according to the third embodiment. Thus, explained below with reference to FIG. 18 are the operations performed when the application 31 outputs a system call. Firstly, when the SSD 17 needs to be adjusted according to the operations performed in the application 31, the access controller 311a of the application 31 sends a system call for reading, writing, or deletion to the system call 41.

Step S31

The counter 312a of the application 31 receives the system call that is output from the access controller 311a. Then, the counter 312a determines whether or not the received system call is a call for reading the data. If the system call is not a call for reading the data (No at Step S31), then the system control proceeds to Step S32. However, if the system call is a call for reading the data (Yes at Step S31), then the system control proceeds to Step S34.

Step S32

The counter 312a determines whether or not the received system call is a call for deletion of the data. If the system call is a call for deletion of the data (Yes at Step S32), then the system control proceeds to Step S33. However, if the system call is not a call for deletion of the data (No at Step S32), then it marks the end of the operations.

Step S33

When the received system call is a call for deletion; the counter 312a resets, in the reading count table 600a, zero as the reading count corresponding to the file name specified in the system call. However, if the system call is a call for writing, it is not always the case that all of the data that is present in the physical sectors 502 constituting the file having the file name specified in the system call is the target data for writing. Thus, when a system call is a call for writing, it is not appropriate to reset zero as the reading count corresponding to the file name specified in the system call. Hence, the reading count is left unchanged. It marks the end of the operations.

Step S34

When the received system call is a call for reading, the counter 312a counts up (increments), in the reading count table 600a, the reading count corresponding to the file name specified in the system call. Moreover, the counter 312a sends the information about the counted-up reading count to the determination processor 313a of the application 31. Then, the system control proceeds to Step S35.

Step S35

The determination processor 313a determines whether or not the reading count received from the counter 312a is equal to or greater than a predetermined upper limit count. If the reading count is equal to or greater than the predetermined upper limit count (Yes at Step S35), then the system control proceeds to Step S36. However, if the reading count is smaller than the predetermined upper limit count (No at Step S35), then it marks the end of the operations.

Step S36

When the reading count is equal to or greater than the predetermined upper limit count; the determination processor 313a sends, to the deleter 314a of the application 31, a deletion command for deleting the file (first data) having the file name corresponding to the reading count in the reading count table 600a. Upon receiving the deletion command from the determination processor 313a; the deleter 314a sends, to the system call 41, a system call for requesting deletion of the file having the file name specified in the deletion command. Upon receiving the system call for deletion from the deleter 314a; the system call 41 sends, to the file system 42, a filter access request for deleting the file having the file name specified in the system call. Upon receiving the file access request for deletion from the system call 41; the file system 42 sends, to the block device 43, a data access request for deleting the data that constitutes the file having the file name specified in the file access request. More particularly, the file system 42 includes, in the data access request to be sent to the block device 43, the logical number corresponding to the target data for deletion. Upon receiving the data access request for deletion from the file system 42; the block device 43 sends, to the device driver 47, the data access request for deleting the data from the logical sector 501 having the logical number specified in the data access request. Upon receiving the data access request for deletion from the block device 43; the device driver 47 sends, to the storage accessing unit 16, a data access request for deleting the data from the logical sector 501 having the logical number specified in the data access request. Upon receiving the data access request for deletion from the device driver 47; the storage accessing unit 16 sends, to the NAND memory controller 171 of the SSD 17, a command for deleting the data from the logical sector 501 having the logical number specified in the data access request. Upon receiving the deletion command from the storage accessing unit 16, the NAND memory controller 171 makes use of a physical command and deletes the data from the logical sector 501 having the logical number specified in the command. Then, at a predetermined timing, the NAND memory controller 171 deletes the data from the physical sector 502 corresponding to the logical sector 501 from which the data was deleted. The system control then proceeds to Step S37.

Step S37

Moreover, the determination processor 313a sends, to the counter 312a, a count resetting request for resetting, in the reading count table 600a, the reading count corresponding to the file name of the target file for deletion. Upon receiving the count resetting request from the determination processor 313a; the counter 312a resets, in the reading count table 600a, zero as the reading count corresponding to the file name specified in the count resetting request. It marks the end of the operations.

In this way, in the information processing device according to the third embodiment, regarding the access controller 441a, the counter 442a, the determination processor 443a, and the deleter 444a implemented by the device driver 44 according to the first embodiment, the equivalent functions are implemented in the application 31 running in the OS 40b. However, reading, writing, and deletion is performed not in units of sectors but in units of files. Hence, the reading count is managed with respect to the file name of each file. With such a configuration too, it becomes possible to achieve the same effect as the effect achieved in the first embodiment. Moreover, as a result of implementing the abovementioned functions in the application 31, the implementation can be done with ease, and the occurrence of the read disturb phenomenon in the SSD 17 can be held down with ease at the application level.

### Fourth Embodiment

In a fourth embodiment, the explanation is given for an example in which the information processing device according to any one of the first to third embodiments is implemented in a web cache server in a network.

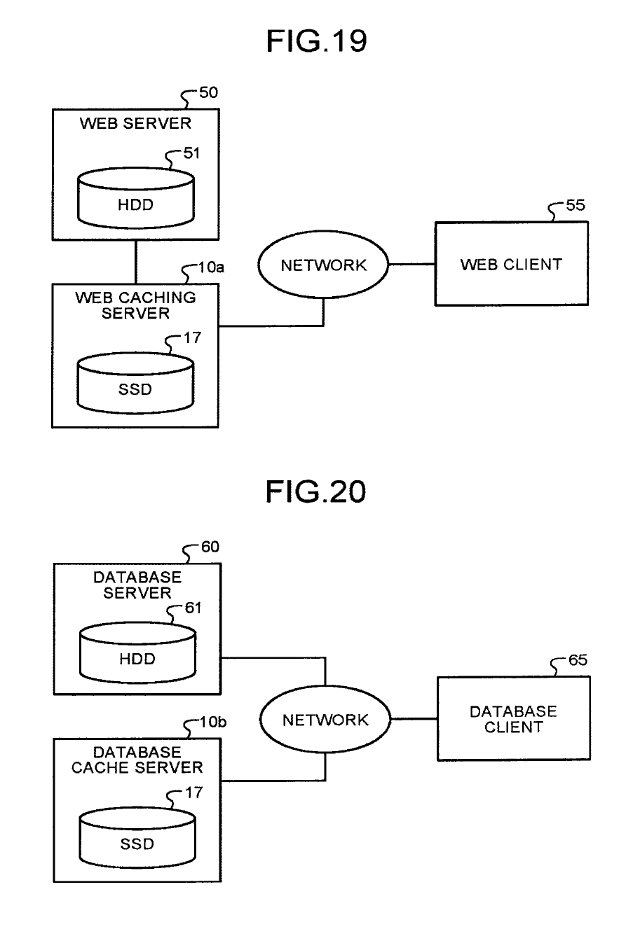

FIG. 19 is a diagram illustrating an exemplary configuration of a client server system according to the fourth embodiment. Thus, explained with reference to FIG. 19 is the brief summary of the configuration of a network configuration according to the fourth embodiment.

As illustrated in FIG. 19, the network configuration according to the fourth embodiment is a client-server-type configuration including a web server 50 (an information providing server), a web cache server 10a that is connected to the web server 50, and a web client 55 that is connected to the web cache server 10a via a network.

The web server 50 is a device or a system that, in the WWW system (WWW stands for World Wide Web), stores therein the contents such as HTML documents (HTML stands for Hyper Text Markup Language) and images; and sends the contents via the network in response to a request from an application such as a browser of the web client 55. The web server 50 includes a hard disk drive (HDD) 51 in which the contents are stored.

The web cache server 10a is a cache server in which the information processing device according to any one of the first to third embodiments is implemented. Thus, the web cache server 10a is a device or a system that stores therein a copy of the contents provided by the web server 50 and, in response to a request from the web client 55, provides the contents on behalf of the web server 50 via the network. The web cache server 10a includes the SSD 17 in which a copy of the contents is stored. In this way, since the web cache server 10a is installed between the web server 50 and the web client 55, it becomes possible to reduce the network traffic and to reduce the load on the web server 50.

The web client 55 is a device or a system that, in response to a user request, requests the web server 50 (or the web cache server 10a) to send the contents; and enables viewing of the contents using an application such as a web browser.

In this way, the information processing device according to any one of the first to third embodiments is implemented in the web cache server 10a of a client-server-type WWW system. As a result, in the SSD 17 included in the web cache server 10a, it becomes possible to hold down the occurrence of the read disturb phenomenon and to hold down an increase in the reading time. Hence, in addition to providing a sophisticated reading-writing function with respect to the SSD 17, it also becomes possible to perform high-speed processing as a cache server.

### Modification Example of Fourth Embodiment

In a modification example, the explanation is given for an example in which the information processing device according to any one of the first to third embodiments is implemented in a database cache server in a network.

FIG. 20 is a diagram illustrating an exemplary configuration of a client server system according to the modification example of the fourth embodiment. Thus, explained below with reference to FIG. 20 is the brief summary of the network configuration according to the modification example.

As illustrated in FIG. 20, the network configuration according to the modification example is a client-server-type configuration including a database server 60 (an information providing server), a database cache server 10b that is connected to the database server 60 via a network, and a database client 65 that is connected to the database server 60 and the database cache server 10b via the network.

The database server 60 is a device or a system that runs a database management system (DBMS), stores therein a variety of data as a database, sends the data that is requested by the database client 65, and rewrites data in response to a request. The database server 60 includes an HDD 61 in which a database is configured and a variety of data is stored.

The database cache server 10b is a cache server in which the information processing device according to any one of the first to third embodiments is implemented. Thus, the database cache server 10b is a device or a system that stores therein a copy of the data provided by the database server 60 and, in response to a request from the database client 65, provides the data on behalf of the database server 60 via the network. The database cache server 10b includes the SSD 1J in which a copy of the data is stored. In this way, the database cache server 10b is installed along with the database server 60. Hence, for example, the data requested by the database client 65 from the database server 60 is stored in the database cache server 10b. Then, if the database client 65 again requests for the same data, then the data can be provided at high speeds from the database cache server 10b.

The database client 65 is a device or a system that, in response to a user request, requests the database server 60 (or the database cache server 10b) to send the data or to rewrite the data in the database.

In this way, the information processing device according to any one of the first to third embodiments is implemented in the database cache server 10b of a client-server-type database system. As a result, in the SSD 17 included in the database cache server 10b, it becomes possible to hold down the occurrence of the read disturb phenomenon and to hold down an increase in the reading time. Hence, in addition to providing a sophisticated reading-writing function with respect to the SSD 17, it also becomes possible to perform high-speed processing as a cache server.

Meanwhile, in the information processing devices according to the embodiments, the explanation is given for an example in which the SSD 17 is used as the memory device having a NAND memory. However, that is not the only possible case. Alternatively, some other type of memory device such as a USB memory or an SD memory card can also be used as the memory device having a NAND memory.

The computer programs, such as the OS and the applications, executed by the CPU 11 in the information processing device according to the embodiments are stored as installable or executable files in a computer-readable storage medium such as a compact disk read only memory (CD-R), a compact disk readable (CD-R), a memory card, a digital versatile disk (DVD), or a flexible disk (FD), each of which may be provided as a computer program product.

Alternatively, the computer programs, such as the OS and the applications, executed by the CPU 11 in the information processing device according to the embodiments can be saved as downloadable files on a computer connected to the Internet or can be made available for distribution through a network such as the Internet. Still alternatively, the computer programs, such as the OS and the applications, executed by the CPU 11 in the information processing device according to the embodiments can be stored in advance in a ROM or the like.

The computer programs, such as the OS and the applications, executed by the CPU 11 in the information processing device according to the embodiments contain modules for implementing the functions that are executed in the CPU 11 in the computer. As the actual hardware, the CPU 11 reads the computer programs from the storage medium (the ROM 12 and the SSD 17) and executes them so that the functions are implemented in the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a storage including a NAND-type flash memory to store data;
an access controller configured to output an access request for accessing the data stored in the storage;
a counter configured to, when the access request represents a request for reading, increment a reading count for a memory area of the storage specified in the access request by one;
a determination processor configured to determine whether or not the reading count reaches a predetermined count; and
a deleter configured to, when the determination processor determines that the reading count reaches the predetermined count, delete first data that is stored in the memory area corresponding to the reading count.

2. The device according to claim 1, wherein the counter is configured to reset the reading count when the determination processor determines that the reading count reaches the predetermined count.

3. The device according to claim 1, wherein the deleter is configured to, when the determination processor determines that the reading count reaches the predetermined count, obtain the first data stored in the memory area corresponding to the reading count, delete the first data stored in the memory area, and newly write, as second data, the obtained first data in the storage.

4. The device according to claim 1, wherein
the access controller is configured to output the access request for data stored in a first memory area that is a memory area in units of sectors in the storage, and
the counter is configured to reset the reading count for the first memory area specified in the access request when the access request represents a request for writing or deletion.

5. The device according to claim 1, wherein
the access controller is configured to output the access request for data stored in a first memory area that is a memory area in units of sectors in the storage,
the storage includes a memory controller configured to hold correspondence information between a logical sector and a physical sector representing the first memory area, and
the memory controller is configured to delete data of a logical sector associated with a physical sector in the correspondence information when the first data stored in the physical sector is to be deleted.

6. The device according to claim 1, wherein the access controller is configured to issue the access request for data stored in a second memory area that is a memory area in units of files in the storage.

7. The information processing device according to claim 6, wherein the counter is configured to reset the reading count for the second memory area specified in the access request when the access request represents a request for deletion.

8. The device according to claim 1, wherein the predetermined count is equal to or smaller than a value obtained by dividing an allowable count for reading for a block of the NAND-type flash memory by the number of pages in a single block.

9. The device according to claim 1, further comprising an interface unit configured to communicate with an information providing server, wherein
the device is configured to function as a cache server for the information providing server.

10. A data accessing method comprising:
outputting an access request for accessing data stored in a storage including a NAND-type flash memory;
incrementing, when the access request represents a request for reading, a reading count for a memory area of the storage specified in the access request by one;
determining whether or not the reading count reaches a predetermined count; and
deleting, when it is determined that the reading count reaches the predetermined count, first data that is stored in the memory area corresponding to the reading count.

11. A computer program product comprising a computer-readable medium containing a program executed by a computer, the program causing the computer to execute:
outputting an access request for accessing data stored in a storage including a NAND-type flash memory;
incrementing, when the access request represents a request for reading, a reading count for a memory area of the storage specified in the access request by one;
determining whether or not the reading count reaches a predetermined count; and
deleting, when it is determined that the reading count reaches the predetermined count, first data that is stored in the memory area corresponding to the reading count.
